(19) United States
(12) Patent Application Publication
(10) Pub. No.: US 2019/0016505 A1
(43) Pub. Date: Jan. 17, 2019

(54) POSTAL MATTER AND THE LIKE

(71) Applicant: Masayuki YOSHIMURA, Fujiyoshida-shi (JP)

(72) Inventors: Masayuki YOSHIMURA, Fujiyoshida-shi (JP); Susumu NAKAYA, Minamiarupusu-shi (JP)

(21) Appl. No.: 16/129,965

(22) Filed: Sep. 13, 2018

Related U.S. Application Data
(63) Continuation-in-part of application No. PCT/JP2017/008742, filed on Mar. 6, 2017.

(30) Foreign Application Priority Data
Mar. 17, 2016 (JP) 2016-053477
Sep. 11, 2016 (JP) 2016-177187
Oct. 12, 2016 (JP) 2016-200486

(51) Int. Cl. B65D 27/06; G06Q 99/00; B65D 27/34

(52) U.S. Cl. CPC B65D 27/06; B65D 27/34; G06Q 99/00

(57) ABSTRACT

The invention provides a postal matter and the like enabling to reduce the burden of postage or delivery charge and printing cost for an advertisement client, and includes an address-described section which a postal address and an addresser-described portion; a first advertising information-described portion which a first advertising information of a first advertisement client; a second advertising information-described portion which a second advertising information or a second advertisement client; a first pre-addressed return mail on which a first response portion and a first pre-addressed return mail for responding to a first advertising information are provided; and a second pre-addressed return mail on which a second response portion and a second pre-addressed return mail for responding to a first advertising information are provided.

### TECHNICAL FIELD

This invention relates to a postal matter and the like to which a pre-addressed return mail is attached.

### BACKGROUND ART

(1) Conventionally, a postal matter to which only one pre-addressed return mail is attached, is known, in which one oblong paper is divided into six sections by folding lines, the sections are folded along the folding lines and facing surfaces are peelably-adhered and integrated into one (for example, Patent Document 1).

(2) Also, as shown in Non-Patent Documents 1 and 2, there is a well-known direct mail agency service in which plurality of direct mails (hereinafter each of the direct mails is referred to as “DM”), on each of which advertising information related to each advertiser (client company) is printed, are enclosed in one envelope. The envelopes in each of which direct mails are enclosed are mailed to targeted people listed in an address list provided by the agency.

### PRIOR ART DOCUMENTS

### Patent Documents

Patent Document 1: U.S. Pat. No. 3,950,983

### Non-Patent Documents

Non-Patent Document 1: “Enclosed DM” http://www.office-criate.com/postdm/flow.php
Non-Patent Document 2: “Joint DM” http://www.open-j.net/service#dm.html

### SUMMARY OF THE INVENTION

### Problems to be Solved by the Invention

In the above-mentioned postal matter of Patent Document 1, one advertiser must bear all costs of postage and printing for the number of sent direct mails and it had been difficult to reduce the burden.

Also, the number of postal addresses had been limited to that listed in the address list owned by the one advertiser. Thus, new customers and/or addresses other than those listed in the address list owned by the one advertiser could not be obtained.

Also, it had been necessary to improve strength of brand and creditworthiness in one's own products and services by one's own.

Also, since the above-mentioned art could not easily lower break-even point, companies which cannot use DMs had been not infrequently.

Also, in the arts of Non-Patent Documents 1 and 2, the postal addresses are limited to those listed in the address list owned by an agency, and therefore the address list owned by a client (the customer list) could not be used as a means to advertisement and the like.

Also, since each DM is printed on different sheets respectively, it had been necessary to platemake, printing-platemake, and print with respect to each DM. In addition, the above arts had needed the costs of putting DMs in an envelope and sealing, and the cost of printing a postal address on the envelope.

Also, the above arts had been not allowed to select advertisement clients and advertising information other than one's own.

In Non-Patent Documents 1 and 2 and mail-order catalogues, it is clear that decreasing advertisement clients (advertisers) to the only four, the only three, and the only two means falling sales revenue and profit into the red.

Then, taking the break-even point into consideration, decreasing advertisement clients to the only four, the only three, and the only two in the case of Non-Patent Documents 1 and 2 or mail-order catalogues, would be difficult.

In view of the disadvantages of the prior art, the purpose of the invention is to provide a group of postal matter and the like accompanied by a pre-addressed postal mail, on which two or more advertising information of two or more advertisement clients are described, and a postal matter and the like constituting the group, as follows: enabling an advertisement client to select the other advertisement client or the other advertising information, which should be described in the postal matter along with his own information and enabling to reduce the burden of postage or delivery charge and printing cost.

To achieve the above purpose, the present invention has the following constitution.

### <Invention Described in Claim 1>

The invention described in Claim 1 is a postal matter and the like comprising;

a sheet member being folded one or more times and adhered peel-openably, or being folded and adhered so as to enable to cut out an edge to open the folded sheet member;

wherein the sheet member has several sections defined by folding lines;

one of the sections or a part thereof is defined as an address-described section which a postal address of one of the targeted people is described; and,

the other remaining sections are allocated to a first advertising information-described portion to a nth advertising information-described portion on each of which a first advertising information to a nth advertising information are printed respectively relating to a first advertiser to a nth advertiser, and a first pre-addressed return mail to a nth pre-addressed return mail which is able to be separated for mailing to the first advertiser to the nth advertiser.

### <Invention Described in Claim 2>

The invention described in Claim 2 is the postal matter and the like according to Claim 1, wherein the sheet member has;

an identifying description which is printed on one or more sides selected from upper, lower, right and left sides of each printed advertising information to visually distinguish each of the advertising information easily; and

other identifying description which is the same or almost the same as the said identifying descriptions and which is printed in each pre-addressed return mail corresponding to each advertising information.

### <Invention Described in Claim 3>

The invention described in Claim 3 is the postal matter and the like according to Claim 1, wherein;

the first pre-addressed return mail to the nth pre-addressed return mail comprise the first pre-addressed return mail and the second pre-addressed return mail, the first pre-addressed return mail to the third pre-addressed return mail, or the first pre-addressed return mail to the fourth pre-addressed return mail; and

the first advertising information to the nth advertising information comprise the first advertising information and the second advertising information, the first advertising information to the third advertising information, or the first advertising information to the fourth advertising information.

### <Invention Described in Claim 4>

The invention described in Claim 4 is the postal matter and the like according to Claim 2, wherein;

the first pre-addressed return mail to the nth pre-addressed return mail comprise the first pre-addressed return mail and the second pre-addressed return mail, the first pre-addressed return mail to the third pre-addressed return mail, or the first pre-addressed return mail to the fourth pre-addressed return mail; and

the first advertising information to the nth advertising information comprise the first advertising information and the second advertising information, the first advertising information to the third advertising information, or the first advertising information to the fourth advertising information.

### <Invention Described in Claim 5>

The invention described in Claim 5 is the postal matter and the like according to Claim 1, wherein;

all of the pre-addressed return mails are printed in one of the sections defined as a pre-addressed return mail-described section; and

a back side of the pre-addressed return mail-described section is to be the said address-described section.

### <Invention Described in Claim 6>

The invention described in Claim 6 is the postal matter and the like according to Claim 2, wherein;

all of the pre-addressed return mails are printed in one of the sections defined as a pre-addressed return mail-described section; and

a back side of the pre-addressed return mail-described section is to be the said address-described section.

### <Invention Described in Claim 7>

The invention described in Claim 7 is the postal matter and the like according to Claim 3, wherein;

all of the pre-addressed return mails are printed in one of the sections defined as a pre-addressed return mail-described section; and

a back side of the pre-addressed return mail-described section is to be the said address-described section.

### <Invention Described in Claim 8>

The invention described in Claim 8 is the postal matter and the like according to Claim 4, wherein;

all of the pre-addressed return mails are printed in one of the sections defined as a pre-addressed return mail-described section; and

a back side of the pre-addressed return mail-described section is to be the said address-described section.

### <Invention Described in Claim 9>

The invention described in Claim 9 is the postal matter and the like according to Claim 1, wherein at least the first advertiser is a publicly-quoted company and advertisers other than the first advertiser are non publicly-quoted company selected from a stock unlisted company, an unlisted organization and a solo proprietor.

### <Invention Described in Claim 10>

The invention described in Claim 10 is the postal matter and the like according to Claim 2, wherein at least the first advertiser is a publicly-quoted company and advertisers other than the first advertiser are non publicly-quoted company selected from a stock unlisted company, an unlisted organization and a solo proprietor.

### <Invention Described in Claim 11>

The invention described in Claim 11 is the postal matter and the like according to Claim 3, wherein at least the first advertiser is a publicly-quoted company and advertisers other than the first advertiser are non publicly-quoted company selected from a stock unlisted company, an unlisted organization and a solo proprietor.

### <Invention Described in Claim 12>

The invention described in Claim 12 is the postal matter and the like according to Claim 4, wherein at least the first advertiser is a publicly-quoted company and advertisers other than the first advertiser are non publicly-quoted company selected from a stock unlisted company, an unlisted organization and a solo proprietor.

### <Invention Described in Claim 13>

The invention described in Claim 13 is the postal matter and the like according to Claim 5, wherein at least the first advertiser is a publicly-quoted company and advertisers other than the first advertiser are non publicly-quoted company selected from a stock unlisted company, an unlisted organization and a solo proprietor.

### <Invention Described in Claim 14>

The invention described in Claim 14 is the postal matter and the like according to Claim 6, wherein at least the first advertiser is a publicly-quoted company and advertisers other than the first advertiser are non publicly-quoted company selected from a stock unlisted company, an unlisted organization and a solo proprietor.

### <Invention Described in Claim 15>

The invention described in Claim 15 is the postal matter and the like according to Claim 7, wherein at least the first advertiser is a publicly-quoted company and advertisers other than the first advertiser are non publicly-quoted company selected from a stock unlisted company, an unlisted organization and a solo proprietor.

### <Invention Described in Claim 16>

The invention described in Claim 16 is the postal matter and the like according to Claim 8, wherein at least the first advertiser is a publicly-quoted company and advertisers other than the first advertiser are non publicly-quoted company selected from a stock unlisted company, an unlisted organization and a solo proprietor.

### Effect of the Invention

As is clear from the above explanation, the effects listed below are provided by the present invention.

### <The Effect of Invention According to Claim 1>

(1) an advertisement client enables to select and decide the other desired advertisement client (hereinafter also referred to as “jointly-described client”) or the other desired advertising information (hereinafter also referred to as “jointly-described advertising information”), which should be described in a postal matter along with own information.

Thus, matching with advantageous or preferable jointly-described client or jointly-described advertising information may be achieved by considering strength and reliability of brand of a jointly-described client; the matching of advertising information of the jointly-described client and one's own; and an area, an age, a sex and a lifestyle of the address list.

(2) For example, when there are the two of a first advertisement client and a second advertisement client, the burden may be shared, e.g., simply halves, and thereby substantially-reducing the burden of cost can be achieved. Thus, break-even point can be lowered and the profit makes it easy to go into the black.

When advertisement clients are the three, the burden per person is ⅓. When advertisement clients are the four, the burden per person is ¼. Thus, the break-even point can be reduced more and moving into the black is become easier. Thereby the barriers for using DMs is substantially lowered, person who could not use them because of the lack of financial resources can become to use.

(3) For example, the two who are going to send 50,000 postal matters (for 50,000 postal addresses) respectively enable to send 100,000 postal matters in total by becoming the first advertising client and the second advertising client.

Thereby, each advertising client can send to 50,000 postal addresses other than those in one's own address list, and a chance to gain new orders or new customers is made by expanding opportunities to catch a customer's eye.

In this case, since the postal addresses are to be twice, the break-even point is naturally lowered by getting chances of improving a hit rate (response rate). Thus, a particular effect that provides a chance to gain new customers, can be achieved.

Also, in terms of cost, the printing cost becomes lower than the case sending total two mails each of which are sent alone, thus reducing the cost in this respect as well.

(4) For Example, even if advertisement clients are the two of the first advertisement client and the second advertisement client but address lists are only a first address list, the first advertisement client can reduce the burden of dispatch cost and the second advertisement client can send own advertising as well as get a chance to gain new customers without possessing own address list.

(5) Placement of two or more advertisements by two or more companies can catch attention and interest of addressees (postal matter recipients), stimulating their motivation for seeing the advertisements.

(6) Since cost reduction and improvement of the response rate (hit rate) by a substantial increase in the postal address lower the break-even point, direct mails become to be easily used financially. Thus, it can achieve the effect that direct mails can become to be easily used by companies which could not previously use direct mails by reasons of lack of funding, non-possession of address list and no-expectations for economic effects.

(7) As mentioned in (1) to (6), the invention enables each advertisement client to select one's preferred advertisement clients and one's preferred advertising information. In addition, the invention enables to flexibly adjust the address list and the cost between the first advertisement client and the nth advertisement client. In this manner, the invention achieves the particular and remarkable effects.

Such selection and adjustment are not achieved by the above-mentioned prior arts, and it is not also possible to reach such concepts.

### <The Effect of Invention According to Claim 2>

The invention has the same effect of the invention according to Claim 1.

### <The Effect of Invention According to Claim 3>

The invention has the same effects of the invention according to Claim 1 or 2 and the postal matter recipient (hereinafter referred to as “recipient”) can clearly differentiate and identify two or more advertising information and pre-addressed return mails by their identifying descriptions. The recipient can thereby write in a response part and the like (entry column) corresponding to the advertising information intending to reply, without making a mistake.

In particular, almost the same identifying description is described in the advertising information side as well as the pre-addressed return mail side. Thus, it is possible to visually and intuitively recognize the advertising information corresponding to the pre-addressed return mail which is in the state of being cut out, without making a mistake.

### <The Effect of Invention According to Claim 4>

The invention has the same effect of the invention according to Claim 1.

### <The Effect of Invention According to Claim 5>

The invention has the same effects of the invention according to Claim 1, 2, 3 or 4. Also, since a pre-addressed return mail-described section which is one section including all pre-addressed mails has a relationship of front-and-back with an address-described section, and the both described sections are provided on the same section of the sheet, missing pieces of advertising information portion are not caused even if each pre-addressed mail is cut apart. Thus, the cut out pre-addressed mail can be juxtaposed with the advertising information corresponding to it and written therein.

### BRIEF DESCRIPTION OF DRAWINGS

FIG. 1 is a plan view (upper figure) and a bottom view (lower figure) according to Example 1 of the invention;

FIG. 2 is a front view illustrating a folding state, a front view illustrating a folded and compression-bonded state and a surface of postal mail, according to Example 1 of the invention;

FIG. 3 is a plan view (upper figure) and a bottom view (lower figure) according to Example 2 of the invention;

FIG. 4 is a plan view (upper figure) and a bottom view (lower figure) according to Example 3 of the invention;

FIG. 5 is a plan view (upper figure) and a bottom view (lower figure) according to Example 5 of the invention;

FIG. 6 is a plan view (upper figure) and a bottom view (lower figure) according to Example 6 of the invention;

FIG. 7 is a plan view (upper figure) and a bottom view (lower figure) according to Example 7 of the invention;

FIG. 8 is a bottom view according to Example 8 of the invention;

FIG. 9 is a plan view (upper figure) and a rear view (lower figure) in a state which is folded along vertical folding lines according to Example 8 of the invention;

FIG. 10 is a bottom view of Example 9 of the invention;

FIG. 11 is a plan view (upper figure) and a bottom view (lower figure) according to Example 10 of the invention;

FIG. 12 is a plan view (upper figure) and a bottom view (lower figure) according to Example 11 of the invention;

FIG. 13 is a plan view (upper figure) and a bottom view (lower figure) according to Example 12 of the invention;

FIG. 14 is a bottom view according to Example 13 of the invention;

FIG. 15 is a bottom view according to Example 14 of the invention;

FIG. 16 is a plan view (upper figure) and a bottom view (lower figure) of a postal matter and the like formed by cutting out, according to Example 14 of the invention;

FIG. 17 is a bottom view according to Example 15 of the invention;

FIG. 18 is a plan view (upper figure) and a bottom view (lower figure) of a postal matter and the like formed by cutting out, according to Example 15 of the invention;

FIG. 19 is a bottom view according to Example 16 of the invention;

FIG. 20 is a plan view (upper figure) and a bottom view (lower figure) according to Example 17 of the invention;

FIG. 21 is a plan view (upper figure) and a bottom view (lower figure) according to Example 18 of the invention.

### MODE(S) FOR CARRYING OUT THE INVENTION

Hereinafter, Examples which is a best mode for carrying out the invention will be described but they do not intend to limit the invention to the Examples. When providing the following explanation of the Examples, parts having the same configurations as a previously mentioned Example are denoted by the same reference numerals for the sake of omitting overlapped explanations.

### Example 1

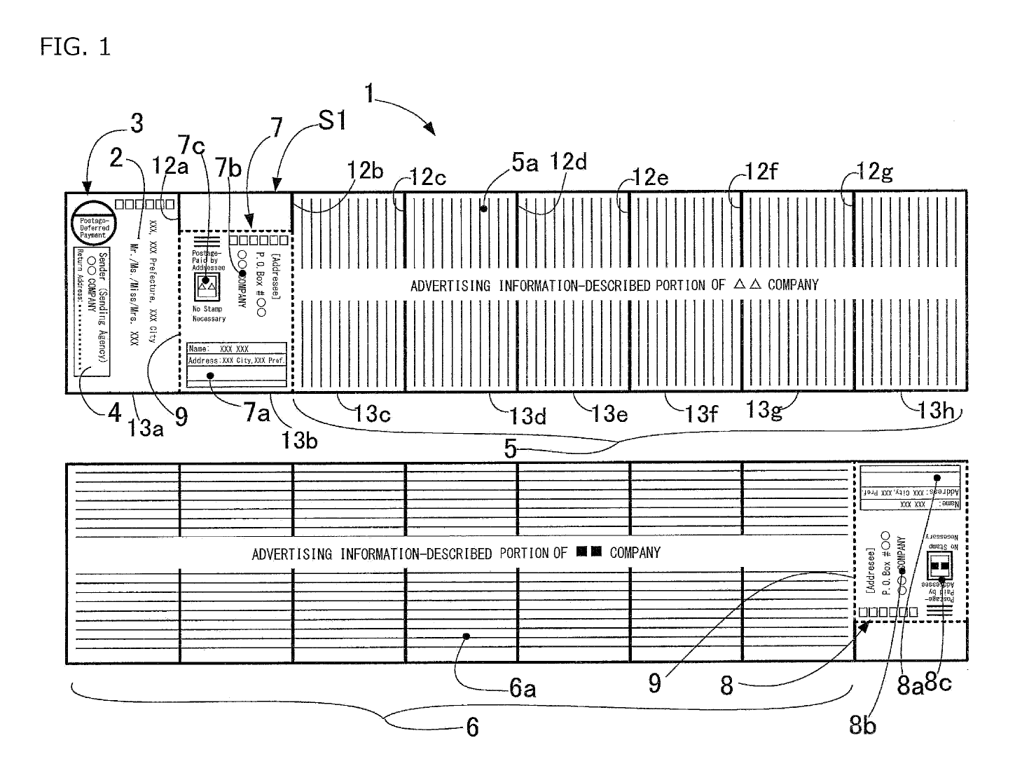

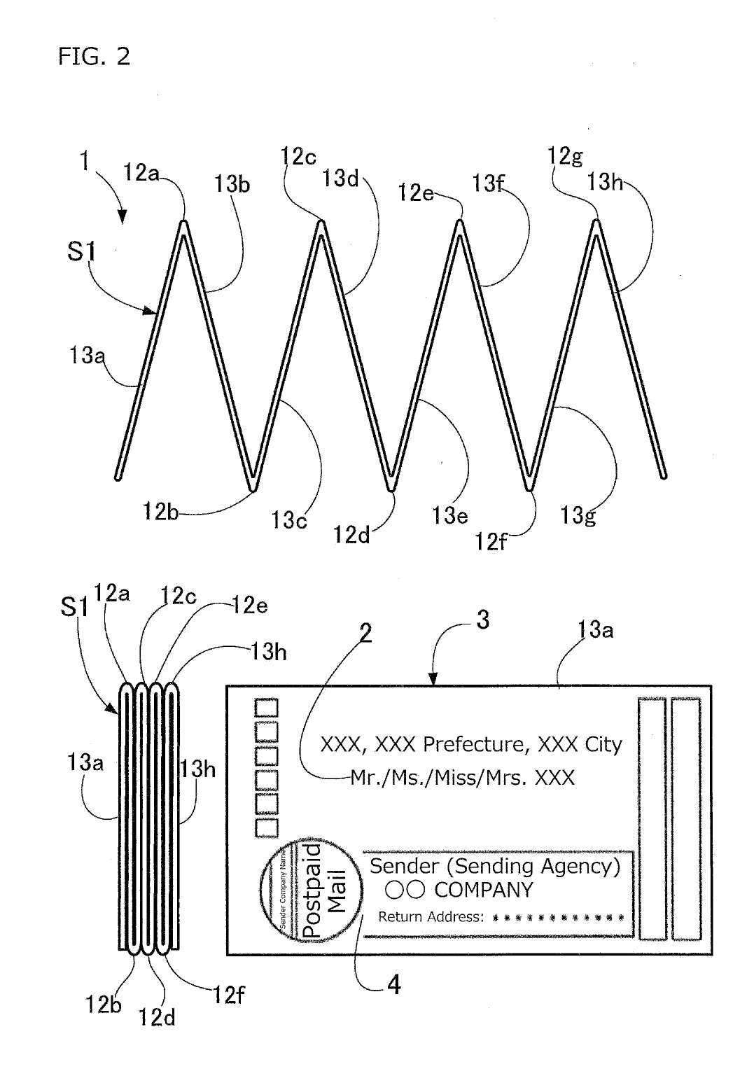

In Example 1 shown in FIGS. 1 and 2, a postal matter and the like 1, which is a primary form of each postal matter and the like, forming a group consisting of many postal matters and the like, have a structure mentioned as follows.

The postal matter and the like 1 have a non-enclosed form that is not enclosed in an envelope. They have a form compression-bonded and wholly or partly adhered peel-openably. Also, they have a form that a sheet member S1 on which information are printed, is folded so that folding lines 12a to 12g and a first section 13a to an eighth section 13h are formed. Each section is formed with each folding line and has the front surface and the back surface.

The postal matter and the like 1 have:

an address-described section 3 on which a postal address 2 of the postal matter and the like (hereinafter referred to as “addressee”) is printed or described through a mailing label and the like;

an addresser-described portion 4 which is described in the address-described section 3 to show an addresser of the postal matter and the like;

a first advertising information-described portion 5 in which a first advertising information 5a of a first advertisement client is described;

a second advertising information-described portion 6 in which a second advertising information 6a different from the first advertising information 5a of a second advertisement client different from the first advertisement client is described;

a first pre-addressed return mail 7 provided on the same surface as the first advertising information 5a, which has a first response portion 7a that an addressee of the postal matter and the like 1 responses to the first advertising information 5a by mail and which has a form to scissor it out of the sheet member S1 along a cut-instructing line 9 to use;

a second pre-addressed return mail 8 provided on the same surface as the second advertising information 6a, which has a second response portion 8a that an addressee of the postal matter and the like 1 responses to the second advertising information 6a by mail and which has a form to scissor it out of the sheet member S1 along the cut-instructing line 9 to use;

a first return mail-identifying portion 7c described in the first pre-addressed return mail 7, which identifies that it is a return mail or a response to the first advertisement client; and

a second return mail-identifying portion 8c described in the second pre-addressed return mail 8, which identifies that it is a return mail or a response to the second advertisement client.

The first pre-addressed return mail 7 and the second pre-addressed return mail 8 which are reply postcards may have a separately usable form which is separated from the sheet member S1 to use. The separately usable form includes a cut-instructing form to cut with scissors from the sheet member S1, a perforating form to enable to tear off with fingers, and a partly connected press-cutting form. The cut-instructing form to cut with scissors is preferable from the aspect of cost because it requires only printing.

The cut-instructing form to cut with scissors is preferable from the aspect of cost because it requires only printing.

The expression “postal matter and the like” includes a postal mail delivered by a post office and a package delivered by a courier such as a delivery company and the like, not to be limited to postal matters handled by the post office.

The advertisement client is preferable to be the two consisting of the first advertisement client and the second advertisement client; the three consisting of the first advertisement client, the second advertisement client and the third advertisement client; or the four consisting of the first advertisement client, the second advertisement client, the third advertisement client and the fourth advertisement client. In such cases, each advertisement client is different, and each advertising information and each return mail-identifying portion corresponding to each advertisement client is provided.

(1) The expression “folded along the folding lines and adhered peel-openably” means a form which each surface of sections facing when folded is peelably-adhered wholly or partly, and the like.

(2) The expression “adhered so as to enable to cut out an edge and open” means a cut-instructing form which enable to be opened by cutting out adhered portions of the edge along the dotted line instructed, a perforating form to enable to tear off with fingers, and the like.

(3) A return address of each pre-addressed return mail includes, for example, cases that it is each advertisement client, cases that it is one advertisement client, and cases that it is a non-advertisement client (e.g., sending agencies, mail-order business companies, direct mail sending business companies, advertising agency business companies, and the like).

(4) “Pre-addressed return mail information” includes descriptions indicating “Postage-Paid by Addressee” and the like and identifying symbols (including number) of addressee which are integrally described with the descriptions (e.g., an approval number given by a post office).

(5) “Each return mail-identifying portion” includes symbols such as numbers, alphabets and any combination thereof and codes such as bar codes, which are given to identify each advertisement client.

Also, when the pre-addressed return mail information is a Post Office-approval number which varies by pre-addressed return mail, each advertisement client may be identified by the Post Office-approval number different from each other. Therefore, this example includes a form that the return mail-identifying portion is composed of a Post Office-approval number and the like.

(6) For example, when advertising information is merchandise sales information, “response portion” may be an application to purchase that, and the like. When advertising information is a questionnaire, “response portion” may be an answer paper to the questionnaire, and the like. When advertising information is an event invitation, “response portion” may be an entry paper for the event, and the like.

(7) An address may be directly printed on the whole or part of the address-described section, or an adhesive label which the address is printed may be attached to the address-described section. The address-described section 3 means a section where an address is described, and advertising information and the like other than the address information may be described within the address-described section 3 in a form distinguished from the address information.

The first advertising information 5a is described on one surface of the sheet member S1 (which means a front surface here and means a plan view in the figure), and the second advertising information 6a is described on the other surface of the sheet member S1 (which means a back surface here and means a bottom view in the figure). Also, the first response portion 7a is described on one surface of the sheet member S1, and the second response portion 8a is described on the other surface of the sheet member S1.

Since the first advertising information 5a is described on the same surface as the first response portion 7a, an addressee can write in the first response portion 7a while seeing the first advertising information 5a and it becomes difficult to write in the second response portion 8a by mistake. This is the same for writing in the second response portion 8a which is on the same surface as the second advertising information 6a.

The sheet member S1 comprises the first section 13a to the eighth section 13h which are serially concatenated by the seven folding lines 12a to 12g. Also, when it is in a form of a postal matter and the like, the first section 13a to the eighth section 13h are folded up, and it takes the peel-openable-adhesion form that the surfaces of the sections facing each other are peel-openably adhered by compression-bonding.

The width of each section does not have to be equal.

The form for folding may be any forms as long as the address-described section 3 is provided on the outermost surface. The examples include a V-fold form, a Z-fold form, a double postcard form, a gate fold form, a double parallel letter fold form, a double indexed letter form, an A4-4P form, an A4-6P form, and the like.

It is preferable that the number of sections is four sections or more (4 sections, 5 sections, 6 sections, 7 sections, 8 sections, 9 sections, 10 sections . . . n sections).

Since this example has a non-enclosed form that is not enclosed in an envelope, the production cost and the used material can be more reduced due to omission of putting into envelope, sealing, and address-printing to envelope.

The type of a postal matter and the like includes postcards, postal matters larger than postcard size (e.g., almost B5 size, almost A4 size, and the like), and the like.

The first section 13a to the eighth section 13h are represented as the same width in the figure. However, the horizontal width and the vertical width of each section may be appropriately designed and set according to a position relationship by folding; an intentional shift or an indicating description (for easily peeling and separating); a pasting part applying varnish or paste for the case of partial adhesion; an overlap width; and the like.

Also, the width of a pre-addressed return mail is not limited as long as it is within the range of “the short side of 90 to 107 mm by the long side of 140 to 154 mm,” which is the size of unofficial postcard.

These same things can be applied to the following examples.

### Example 2

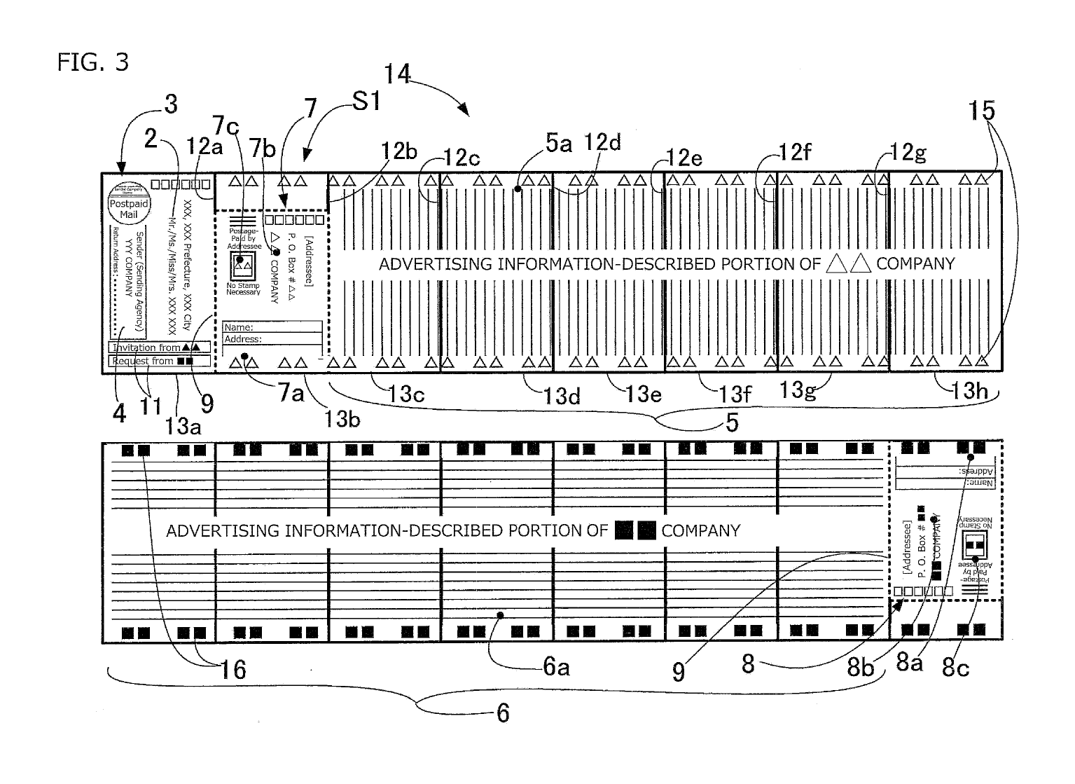

In Example 2 shown in FIG. 3, a primary difference with the above-mentioned Example 1 is that Example is a postal matter and the like 14 in which a first identifying description 15 and a second identifying description 16 are described to visually identify each advertising information-described portion (which corresponds a first advertising information-described portion 5 and a second advertising information-described portion 6 here) more easily.

The first identifying description 15 and the second identifying description 16 respectively have a length which can visually divide the first advertising information-described portion 5 and the second advertising information-described portion 6. Also, they have a form described over each pre-addressed return mail and each advertising information-described portion.

It is preferable that the identifying descriptions 15 and 16 are a description unique to client, which consists of full names, names, logos, character images, brand marks, brand colors, product names, product photos, product images, service names, service images or combinations thereof, which each advertisement client (which corresponds a first advertisement client and a second advertisement client here) uses or is trying to use.

Also, they may be a simple form such as mere lines with different colors.

The first advertising information-described portion 5 and a first pre-addressed return mail 7 are provided on one surface of a sheet, and the first identifying description 15 is described by printing so as to extend over the first advertising information-described portion 5 and the first pre-addressed return mail 7. Also, the second advertising information-described portion 6 and a second pre-addressed return mail 8 are provided on the other surface of a sheet, and the second identifying description 16 is described by printing so as to extend over the first advertising information-described portion 6 and the second pre-addressed return mail 8.

Such arrangement of description includes a form which the first pre-addressed return mail 7 is included within the range of the first advertising information-described portion 5, and a form which the second pre-addressed return mail 8 is included within the range of the second advertising information-described portion 6.

Addressees corresponding to each postal address can clearly distinguish and identify two or more advertising information-described portion s (which are the first advertising information-described portion 5 and the second advertising information-described portion 6 here), respectively, by the identifying descriptions 15 and 16. Therefore, they can make an entry in each response portion (which corresponds a first response portion 7a and a second response portion 8a here) corresponding to the advertising information which they intend to respond (which corresponds a first advertising information 5a and a second advertising information 6a here), without making a mistake.

Specifically, in the case of “an identifying description having a length over each pre-addressed return mail and each advertising information-described portion,” the same identifying description leaves on the side of the advertising information-described portion even after the pre-addressed return mail is cut apart. Thus, checking and entering after being cut apart, can be carried out without a mistake.

When the identifying descriptions 15 and 16 are a client's unique description which is unique to each client, each advertising information can be visually clearly distinguished and identified which information corresponds to which clients, in a moment. Thus, a mistake of combination becomes to be difficult to occur.

An introduction-described portion 11 in which a simple introduction regarding the first advertising information 5a and the second advertising information 6a that cannot be seen when unopened is described, is provided on an address-described section 3.

This serves to give motivation to open a postal matter and the like by getting the addressee to intuitively understand the point of contents of information in the postal matter and the like.

Also, advertising information other than those of the advertisement clients may be described in the introduction-described portion 11.

In Example 2, a return address of a pre-addressed return mail information 7b is the first advertisement client, and a return address of a pre-addressed return mail information 8b is the second advertisement client.

A first return mail-identifying portion 7c is the first Post Office-approval number of the post office specified by the first advertisement client, and a second return mail-identifying portion 8c is the second Post Office-approval number of the post office specified by the second advertisement client.

Also, the first and second Post Office-approval numbers may be other Post Office-approval numbers for a sending agency and the like who are not the first and second advertisement clients.

### Example 3

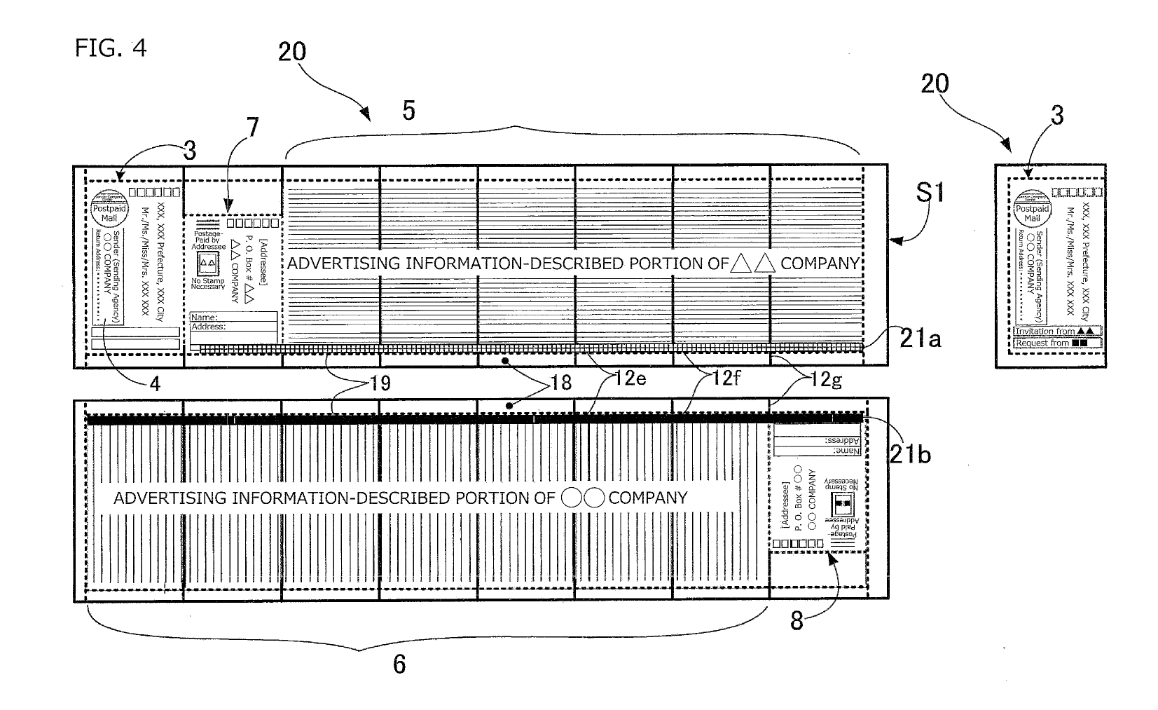

In Example 3 shown in FIG. 4, a primary difference with the above-mentioned Example 1 is that Example 3 is a postal matter and the like 20 having:

an overlap width 18 provided over whole circumference of the sheet member S1 and

a dotted opening line 19 for tearing off the overlap width 18 with fingers, without adopting the form of for peel-openably adhesion.

This opening form by the dotted opening line 19 is an adhered three side-cutting-to-open form prepared by prepared by folding one sheet member and adhering a cutting-portion to allow three sides of the folded sheet to be cut.

Also, an identifying description 21a which is the first color band form, is provided on the lower side of a first advertising information-described portion 5 and a first pre-addressed return mail 7. An identifying description 21b which is the second color line form, is provided on the lower side of a second advertising information-described portion 6 and a second pre-addressed return mail 8.

### Example 4

In Example 4 (non-correspondence figures), a primary difference with the above-mentioned Example 1 is that postal addresses derive from the first address list of the first advertisement client or the second address list of the second advertisement client but not both.

When the postal addresses derive from the first address list, the sender is to be the first advertisement client. When the postal addresses derive from the second address list, the sender is to be the second advertisement client.

Example 4 is a postal matter and the like whose address is an address from the address list of ether the first advertisement client or the second advertisement client.

Thereby, the following agreement for burden sharing may be easy achieved:

for example, when the postal addresses are only an address from the first address list, the second advertisement client who does not provide his address list incurs almost or all costs. Also, even if advertisement clients do not possess any address lists, they can get a chance to gain new orders of their products and services, recognition, and new customers, without address lists.

### Example 5

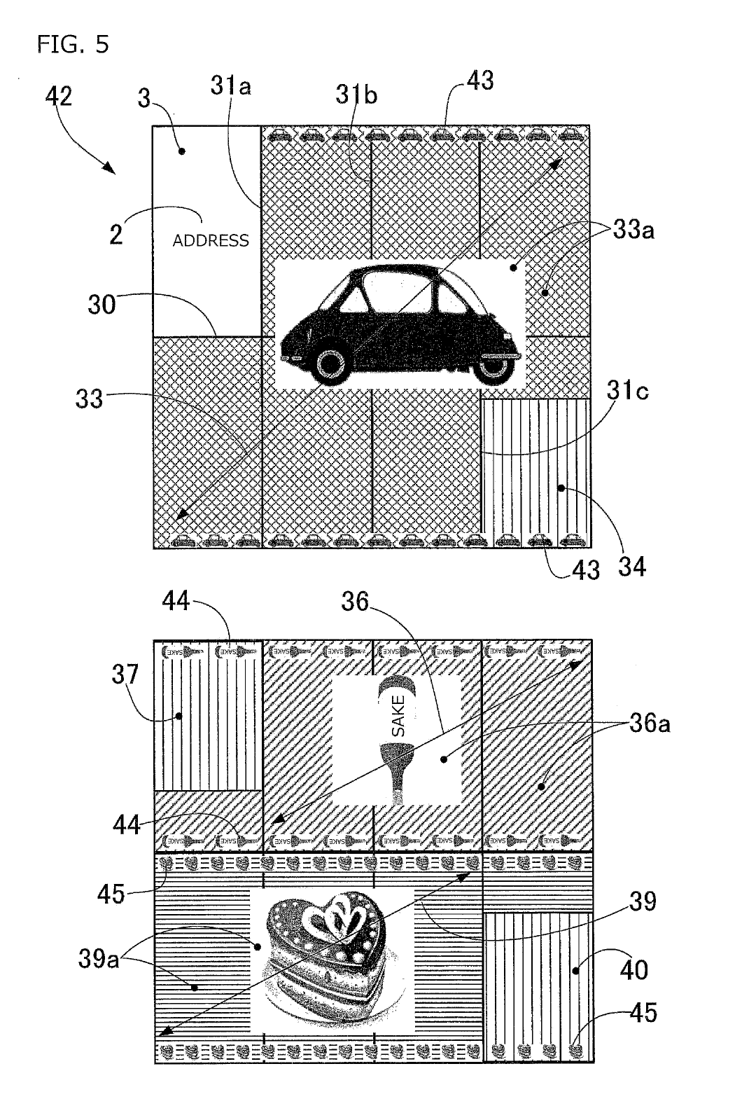

In Example 5 shown in FIG. 5, a primary difference with the above-mentioned Example 1 is that Example 5 is a postal matter and the like 42 having:

a sheet member S2 being large in the upper and lower widths which a horizontal folding line 30 in the almost center and vertical folding lines 31a, 31b and 31c are formed and

a folded form obtained by folding up eight sections formed by the folding lines,

wherein a first advertising information-described portion 33, which a first advertising information 33a and a first pre-addressed return mail 34 of the first advertisement client who is a stock listed company are printed on one surface which a postal address 2 is described, is provided;

wherein a second advertising information-described portion 36, which a second advertising information 36a and a second pre-addressed return mail 37 of the second advertisement client who is a stock unlisted company are printed on the almost upper half of the other surface, is provided;

wherein a third advertising information-described portion 39, which a third advertising information 39a and a third pre-addressed return mail 40 of the third advertisement client who is a stock unlisted company are printed on the almost lower half of the other surface, is provided.

In the postal matter and the like 42 having a form of mailable postal matter and the like, a peel-openable adhesive is applied on:

the whole of one surface of the sheet member S2 and the whole of the other surface of the sheet member S2;

the part of one surface of the sheet member S2 and the part of the other surface of the sheet member S2; or

the part of one surface of the sheet member S2 or the part of the other surface of the sheet member S2. Then the eight sections are folded up along the folding lines so that an address-described section 3 is provided on the outermost surface, and the folded-up sheet member is compression-bonded to peel-openably adhere each section facing each other.

The second advertising information-described portion 36 and the third advertising information-described portion 39 are different in a character writing direction (text directions [vertical writing and horizontal writing]) and an orientation of their images. Thereby, an advertising information-described portion different from the advertising information-described portion currently being viewed, is to be difficult to view and understand the contents. Therefore, it enables to focus on the advertising information currently viewing without being deprived his/her attention by other advertising information and the like.

In the address-described section 3, the postal address 2, a destination address, an addresser-described portion 4, information such as “Postage-Deferred Payment”, and the like are described.

In the first pre-addressed return mail 34, the first response portion, the first pre-addressed return mail information and the first return mail-identifying portion are described.

In the second pre-addressed return mail 37, the second response portion, the second pre-addressed return mail information and the second return mail-identifying portion are described.

In the third pre-addressed return mail 40, the third response portion, the third pre-addressed return mail information and the third return mail-identifying portion are described.

On the top and bottom of the first advertising information-described portion 33, the first identifying description 43 on which reduced product images are arranged side by side in belt-like form, is printed.

On the top and bottom of the second advertising information-described portion 36, the second identifying description 44 in which reduced product images are arranged side by side in belt-like form, is printed.

On the top and bottom of the third advertising information-described portion 39, the third identifying description 45 in which reduced product images are arranged side by side in belt-like form, is printed.

### Example 6

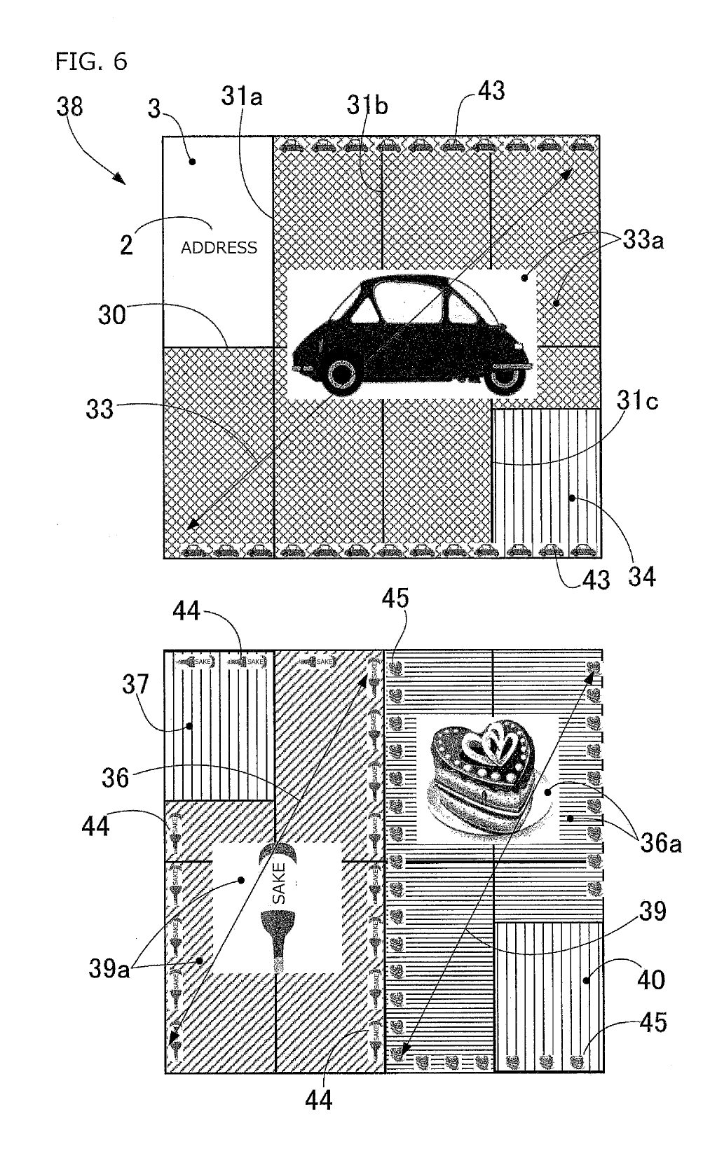

In Example 6 shown in FIG. 6, a primary difference with the above-mentioned Example 5 is that Example is a postal matter and the like 38 in the transverse arrangement form in which a second advertising information-described portion 36 is arranged on the left side of the figure and in which a third advertising information-described portion 39 is arranged on the right side of the figure.

Both of the character writing directions in the second advertising information-described portion 36 and the third advertising information-described portion 39 are horizontal writing. Also, an orientation of their images and characters is opposite each other.

### Example 7

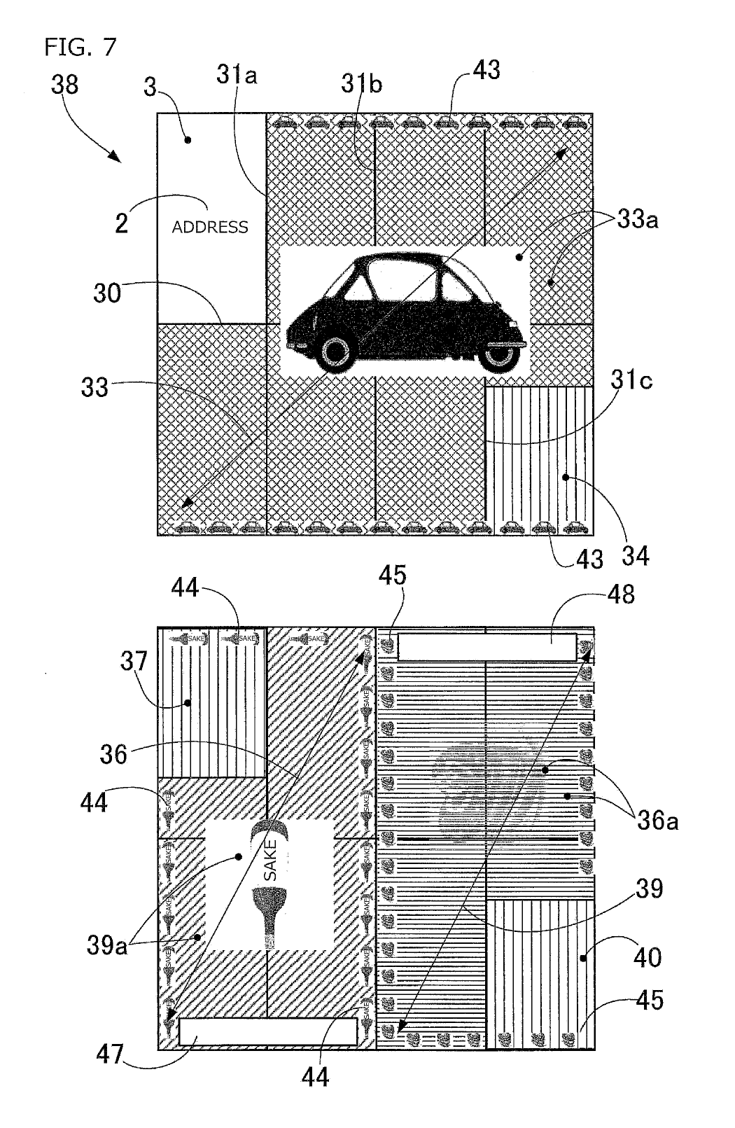

In Example 7 shown in FIG. 7, a primary difference with the above-mentioned Example 6 is that an introduction sentence 47 is described in a second advertising information-described portion 36 and that an introduction sentence 48 is described in a third advertising information-described portion 39.

In the introduction sentence 47, introduction sentences such as recommendations and assistance, which the first advertisement client who is a stock listed company recommends and assists the second advertisement client oneself and its products and services described in a second advertising information 36a, are described.

In the introduction sentence 48, introduction sentences such as recommendations and assistance, which the first advertisement client who is a stock listed company recommends and assists the third advertisement client oneself and its products and services described in a third advertising information 39a, are described.

The introduction sentence includes:

a collecting report regarding the tradition, the personality of manager, person in charge and the like, the mind or philosophy, the manufacturing process, and the like for the second or third advertisement client;

an introduction of the products or services and the reasons for recommendation; and

a review, a feedback and the like by the employees of the first advertisement client who actually used the product or services of the second or third advertisement client, such as an example “45 of 50 employees of our company are saying XXXX.”

### Example 8

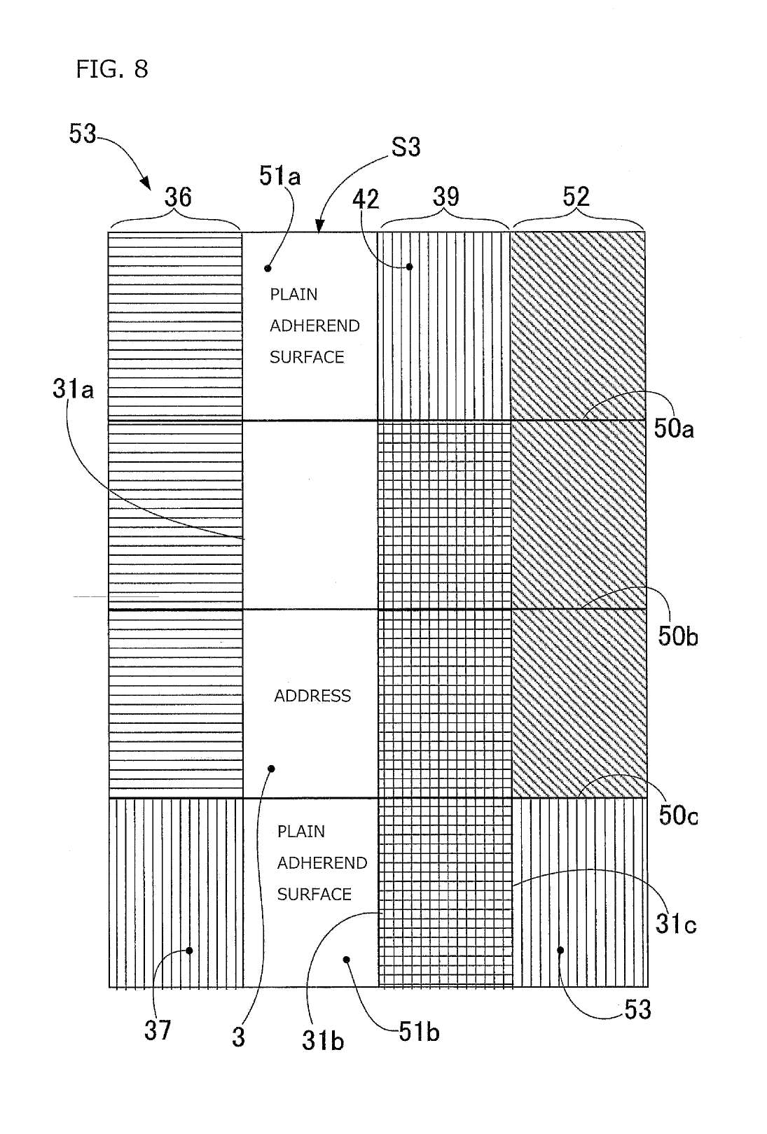

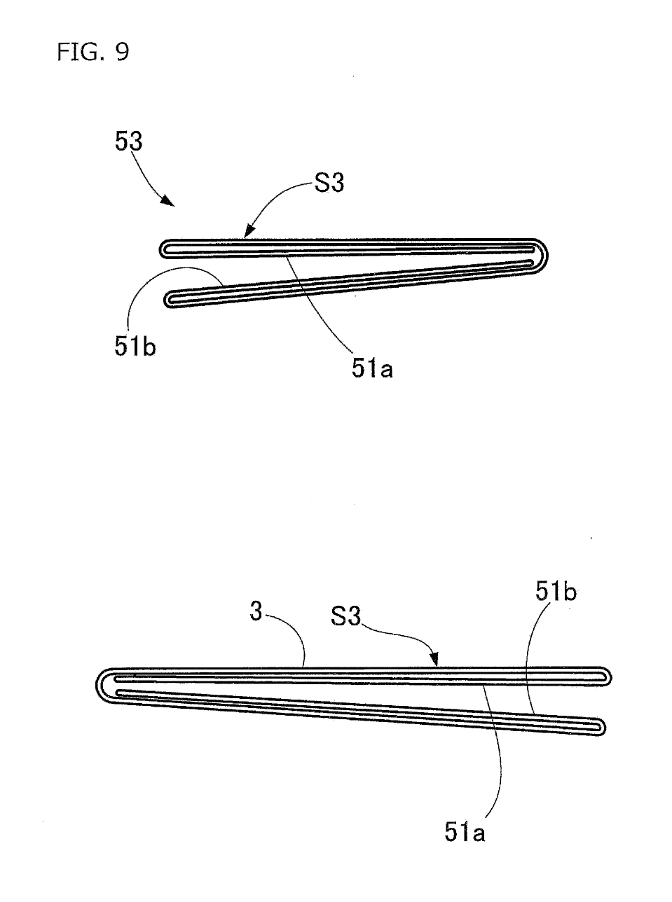

In Example 8 shown in FIGS. 8 and 9, a primary difference with the above-mentioned Example 6 is that it is a postal matter and the like 53 having a sheet member S3 having a larger area than the sheet member S2,

wherein three horizontal folding lines 50a, 50b and 50c are formed as a horizontal folding line;

wherein, on one surface, a square in the second column and the first row is an adherend surface 51a, a square in the second column and the fourth row is an adherend surface 51b, a square in the second column and the third row is an address-described section 3, all squares in the first column is a second advertising information-described portion 36, all squares in the third column is a third advertising information-described portion 39, and all squares in the fourth column is a fourth advertising information-described portion 52 of the forth advertisement client; and

wherein the other surface is a first advertising information-described portion 33.

In a fourth advertising information-described portion 52, a fourth pre-addressed return mail 53 having the forth response portion, the fourth pre-addressed return mail information, and the fourth return mail-identifying portion, is provided.

With facing up an address-described section 3, the second advertising information-described portion 36 is folded towards back side along a vertical folding line 31a, the fourth advertising information-described portion 52 is folded towards back side along a vertical folding line 31c, the third advertising information-described portion 39 is folded towards back side along a vertical folding line 31b together with the fourth advertising information-described portion 52, the side of the first adherend surface 51a is folded towards back side along the horizontal folding line 50a, the side of the second adherend surface 51b is folded towards back side along the horizontal folding line 50c, and the obtained product is folded towards back side along the vertical folding line 50b so that the first adherend surface 51a and the second adherend surface 51b face each other.

The product in the folded state is compression-bonded by a compression-bonding apparatus to adhare (bond) the first adherend surface 51a and the second adherend surface 51b.

On the first adherend surface 51a and the second adherend surface 51b, a peel-openable adhesive is applied, and advertising information and the like are not printed (they are represented as a non-printed plain surface in the figure). Also, in the folded postal matter and the like at the mailing state, the first adherend surface 51a and the second adherend surface 51b are peel-openablly adhered by compression-bonding.

Since the surfaces on which the adhesive is applied, are only the first adherend surface 51a and the second adherend surface 51b which are facing, the compression-bonded surface is one. It is therefore only necessary for a pressure in the compression-bonding to be adjusted to the optimum pressure for that one compression-bonded surface. Thus, an adhesion pressure gets hard to be uneven, and thereby a high-precision compression-bonding may be achieved.

Also, the adhesive usage may be significantly reduced.

On the first adherend surface 51a and the second adherend surface 51b, an advertising information and the like are not printed and the first adherend surface 51a and the second adherend surface 51b are plain. Therefore, even if the surface of the adhered sheet is plucked off by a failure of peel-off due to too strong the adhesion force when peel-opening a postal matter and the like, any problem in sense of beauty and use will not be caused.

Thus, a peel-openable adhesion which the pressure at compression-bonding (compression-bonding adhesion) is strengthen, may be possible.

### Example 9

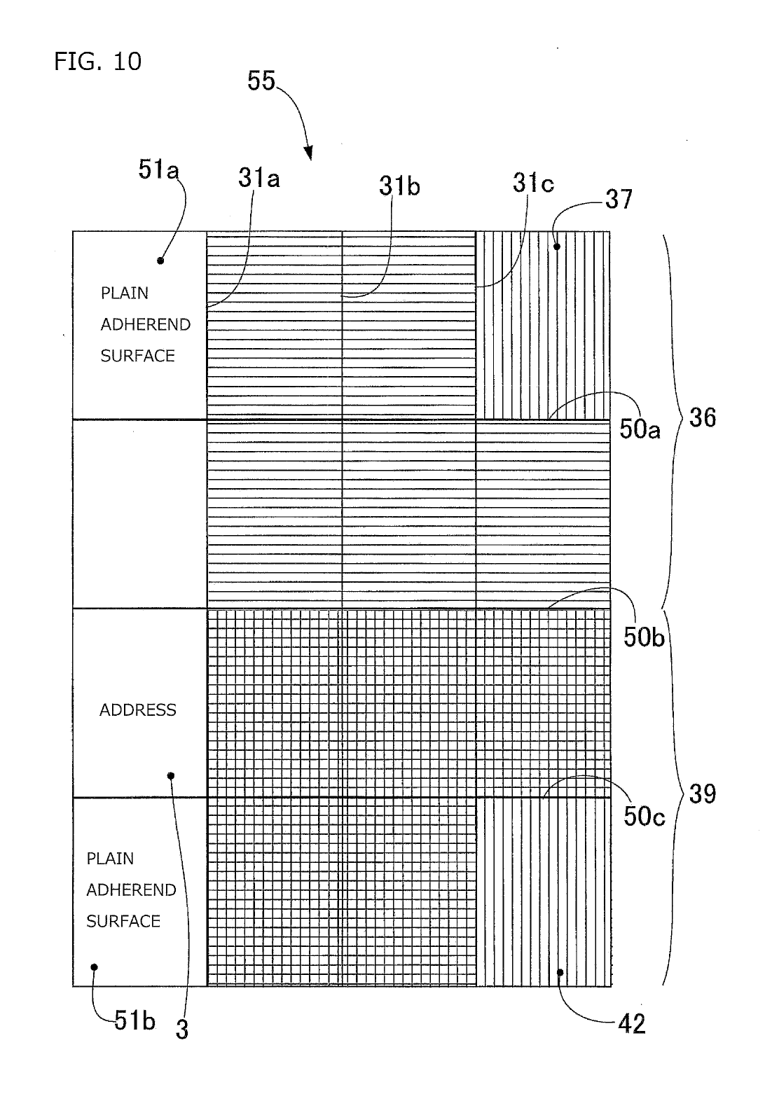

In Example 9 shown in FIG. 10, a primary difference with the above-mentioned Example 8 is that Example 9 is a postal matter and the like 55:

wherein a first adherend surface 51a, a second adherend surface 51b, and a address-described section 3 are arranged in the first column;

wherein a second advertising information-described portion 36 is the upper half;

wherein a third advertising information-described portion 39 is the lower half; and

wherein a fourth advertising information-described portion 52 is not provided.

With facing up an address-described section 3, the fourth column (the first column from the left side in the figure) is folded towards back side along a vertical folding line 31c, the third column is folded towards back side along a vertical folding line 31b together with the fourth column, the second column is folded towards back side along a vertical folding line 31a together with the third column and the fourth column, the side of the first adherend surface 51a is folded towards back side along a horizontal folding line 50a, the side of the second adherend surface 51b is folded towards back side along a horizontal folding line 50c, and the obtained product is folded towards back side along a vertical folding line 50b so that the first adherend surface 51a and the second adherend surface 51b face each other.

The product in the folded state is compression-bonded by a compression-bonding apparatus to adhare (bond) the first adherend surface 51a and the second adherend surface 51b.

### Example 10

A postal matter and the like 59 of Example 11 shown in FIG. 10 is primarily different from the above-mentioned Example 8 in the following points.

A sheet member S4 comprises:

four folding lines of a first folding line 60a to a fourth folding line 60d; and

five sections per surface, i.e., ten sections on both surfaces, which are composed of
sections 61a to 61e separated by the folding lines on one side (front surface) and
sections 62a to 62e separated by the folding lines on the other side (back surface). Each one section has the same size as almost A4 size (≈210 mm by 297 mm), but the invention is not limited to this size.

The section 61c which is a central section of the front surface is referred to as an address-described section 3, and the section 62c which is the opposite surface (a central section of the back surface) is referred to as a pre-addressed return mail-described section 63 on which the first pre-addressed return mail 64a to the fourth pre-addressed return mail 64d, which are reply postcards, are described.

The descriptions of the first pre-addressed return mail 64a to the fourth pre-addressed return mail 64d is almost the same as those of the first pre-addressed return mail 7, the second pre-addressed return mail 8 and the like which are mentioned in the above Example 1.

Advertisement clients are the four composed of the first advertisement client to the fourth advertisement client. Also, advertising information are four different advertising information consisting of a first advertising information 65a of the first advertisement client, a second advertising information 65b of the second advertisement client, a third advertising information 65c of the third advertisement client, and a fourth advertising information 65d of the fourth advertisement client.

The sections 61a and 61b which are located in the left side of the address-described section 3 (the section 61c) on the front surface, are referred to as a second advertising information-described portion 66b on which the second advertising information 65b is described by printing.

The sections 61c and 61d which are located in the right side of the address-described section 3, are referred to as a fourth advertising information-described portion 66d on which the fourth advertising information 65d is described by printing.

The sections 62a and 62b which are located in the left side of the pre-addressed return mail-described section 63 on the back surface, are referred to as a first advertising information-described portion 66a on which the first advertising information 65a is described by printing.

The sections 62d and 62e which are located in the right side of the pre-addressed return mail-described section 63 on the back surface, are referred to as a third advertising information-described portion 66c on which the third advertising information 65c is described by printing.

A first identifying description 67a is described in the first advertising information-described portion 66a and the first pre-addressed return mail 64a, a second identifying description 67b is described in the second advertising information-described portion 66b and the second pre-addressed return mail 64b, a third identifying description 67c is described in the third advertising information-described portion 66c and the third pre-addressed return mail 64c, and a fourth identifying description 67d is described in the fourth advertising information-described portion 66d and the fourth pre-addressed return mail 64d.

### Example 11

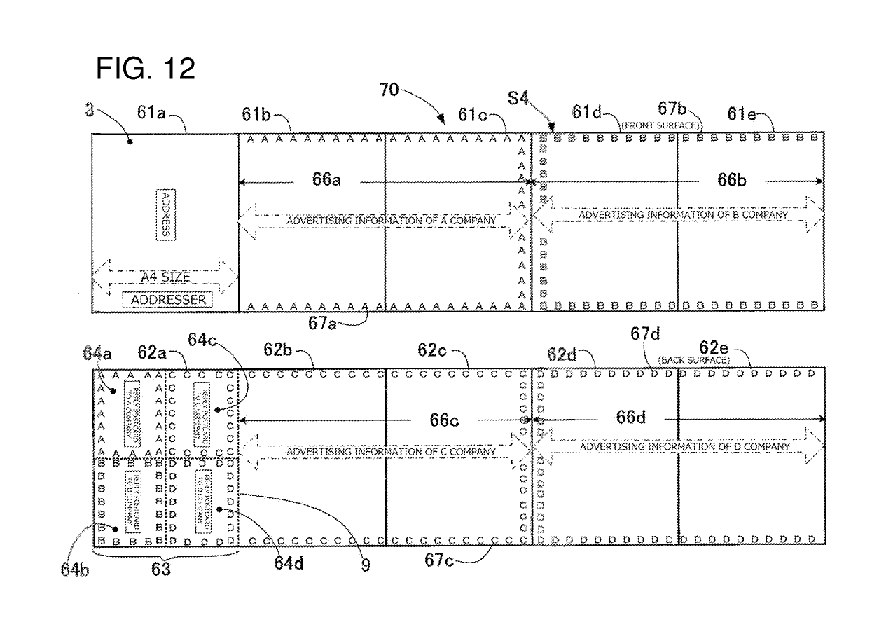

In Example 11 shown in FIG. 12, a primary difference with the above-mentioned Example 10 is that Example 11 is a postal matter and the like 70:

wherein an address-described section 3 is located in the portion of a section 61a;

wherein a pre-addressed return mail-described section 63 is located in the portion of a section 62a;

wherein a first advertising information-described portion 66a is located in the portion of sections 61b and 61c;

wherein a second advertising information-described portion 66b is located in the portion of sections 61d and 61e;

wherein a third advertising information-described portion 66c is located in the portion of sections 62b and 62c; and

wherein a fourth advertising information-described portion 66d is located in the portion of sections 62d and 62e.

### Example 12

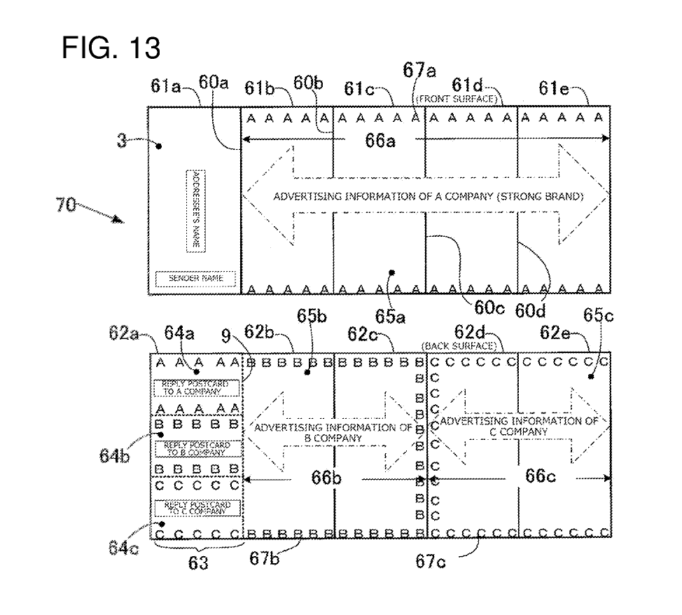

In Example 12 shown in FIG. 13, a primary difference with the above-mentioned Example 11 is that Example 12 is a postal matter and the like 74:

wherein advertising information are a first advertising information 65a, a second advertising information 65b and a third advertising information 65c which are derived from three advertisement clients composed of the first, second and third advertisement clients;

wherein pre-addressed return mails are a first pre-addressed return mail 64a, a second pre-addressed return mail 64b and a third pre-addressed return mail 64c;

wherein identifying descriptions are a first identifying description 67a, a second identifying description 67b and a third identifying description 67c;

wherein the first pre-addressed return mail 64a, the second pre-addressed return mail 64b and the third pre-addressed return mail 64c, which are turned sideways, are vertically arranged in a pre-addressed return mail-described section 63.

The size of the pre-addressed return mail-described section 63 is the size when three postcards turned sideways are vertically arranged. Thus, the size of each of sections 61a to 61e and sections 62a to 62e becomes the almost same as the size of the pre-addressed return mail-described section 63.

Since the size of unofficial postcard is specified to “the short side of 90 to 107 mm by the long side of 140 to 154 mm,” the horizontal width of the pre-addressed return mail-described section 63 is 140 to 154 mm and the vertical width of the pre-addressed return mail-described section 63 is 270 to 321 mm.

The first advertisement client is a stock listed company, and the second and third advertisement clients are stock unlisted companies.

In such cases, for example, only the first advertisement client provides the address list to eliminate or reduce the burden of cost for the second and third advertisement clients, and thereby the first advertisement client who is a stock listed company may assist or support the second and third advertisement clients who are a stock unlisted company.

### Example 13

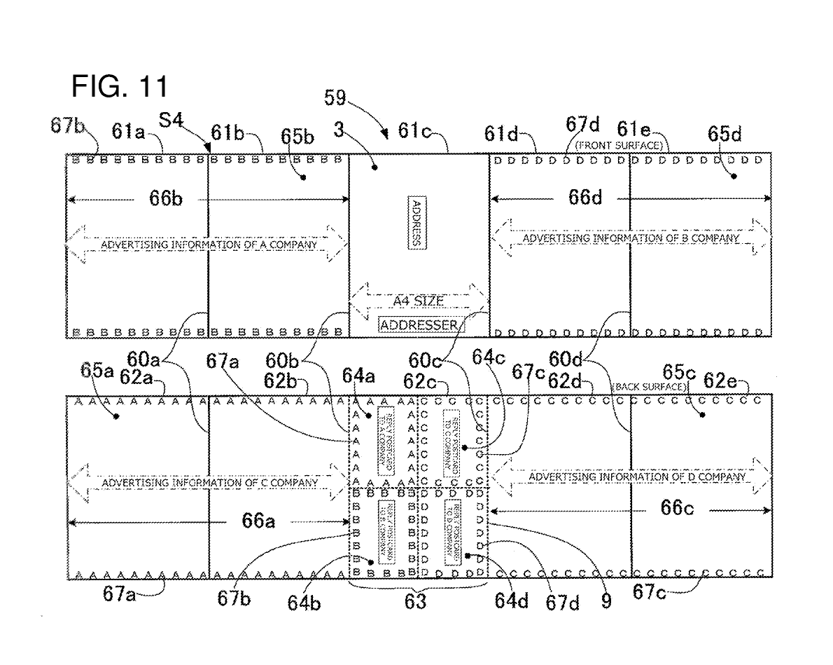

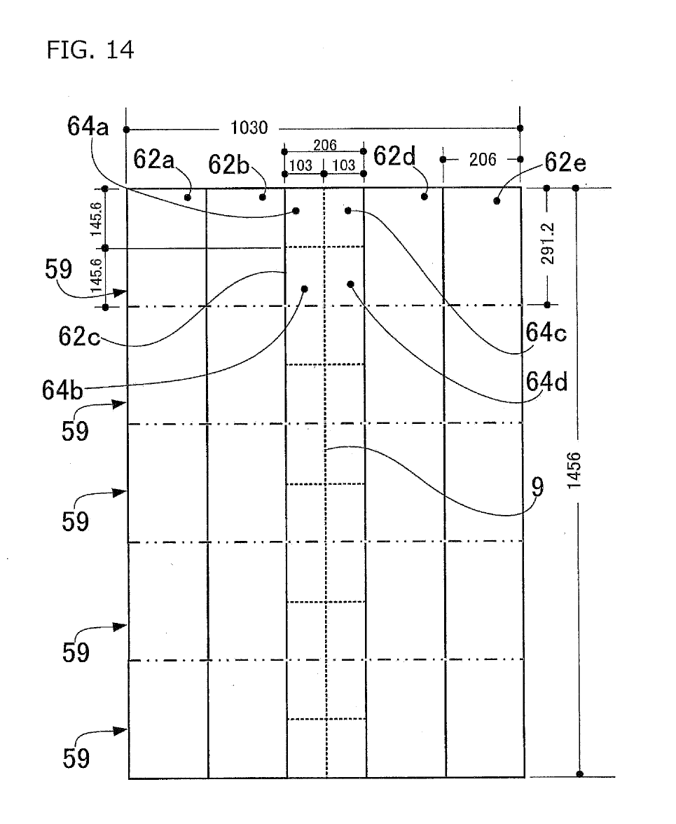

Example 13 shown in FIG. 14, gives an example that five postal matters and the like 59 (Example 10 in FIG. 11) are printed on a printing base paper which is BO size (the short side of 1030 mm by the long side of 1456 mm). A dashed-and-double-dotted line shows a cutting line along which is cut with a cutting machine (a paper cutter), which is not generally marked by a printed line and the like.

Five postal matters and the like 59 are printed on the front and back surfaces of a BO size base paper, and then each printed postal matter and the like 59 is cut out along the cutting line to obtain separated postal matters and the like 59. After an adhesive is applied on a part required to be applied, the postal matter and the like 59 is folded by a folding machine, compression-bonded and adhered to finish a postal matter.

The size of one section is here referred to as the short side of 206 mm by the long side of 291.2 mm. While A4 size has a short side of 210 mm and a long side of 297 mm, the said short side is 4 mm longer than that of A4 size and the said long side is 5.8 mm shorter than that of A4 size. Also, each size of a first pre-addressed return mail 64a to a fourth pre-addressed return mail 64d is here referred to as the short side of 103 mm by the long side of 145.6 mm, but not limited to this. The size of a pre-addressed return mail may be within the range of “the short side of 90 to 107 mm by the long side of 140 to 154 mm,” which is the size of unofficial postcard. The horizontal width and the vertical width of each section may be appropriately set according to a position relationship by folding, an intentional shift or an indicating description (for easily peeling and separating), a pasting part applying varnish or paste for the case of partial adhesion (an overlap width and the like), and the like.

The cutting line is provided on the side of the short side of each section, and a section for pre-addressed return mails (a section 62c) and an address-described section 3, which is on the opposite side of the section 62c, are arranged on the center side of the long side of the postal matter and the like 59.

### Example 14

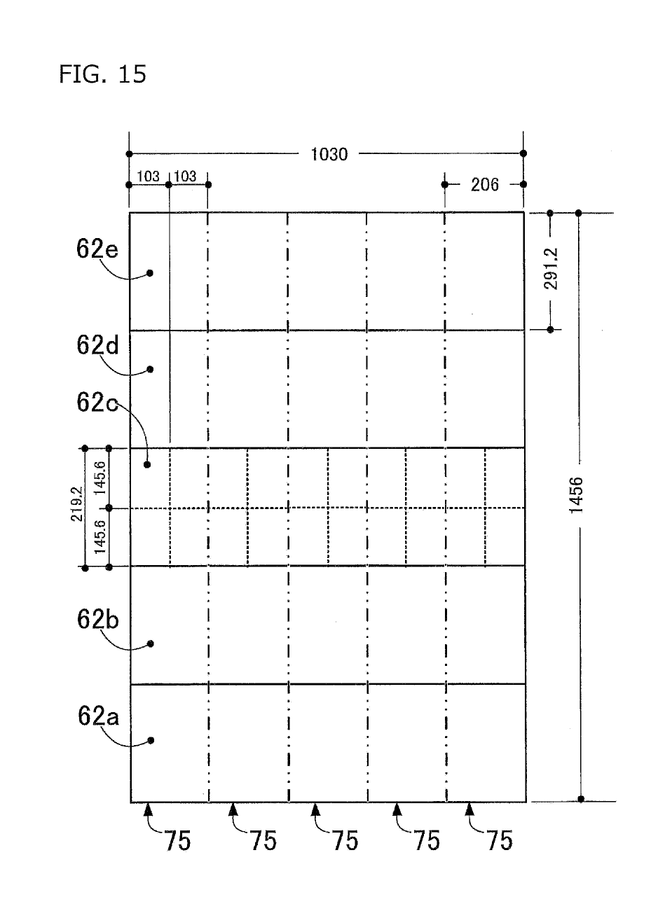

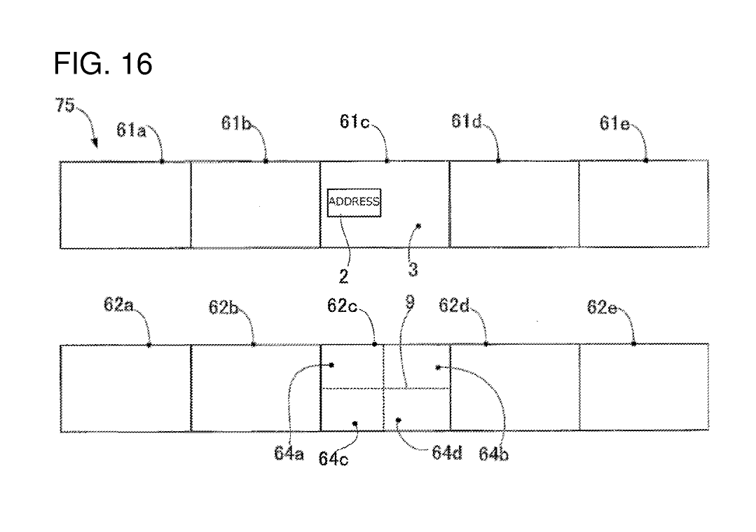

In Example 14 shown in FIGS. 15 and 16, a primary difference with the above-mentioned Example 13 is that Example 14 is a postal matter and the like 75 which differs from the postal matter and the like 59 in orientation of sections. In the postal matter and the like 75, a cutting line on a base paper is provided on the side of the long side of each section, and a section for pre-addressed return mails and an address-described section 3, which is on the opposite side of the section for pre-addressed return mails, are arranged on the center of the side of the short side of the postal matter and the like 75. Therefore, after cutting out, a postal matter and the like having the form shown in FIG. 16, may be obtained.

In the postal matter and the like 75, the orientation of the first pre-addressed return mail 64a to the fourth pre-addressed return mail 64d and sections 62a to 62e is different from that in the postal matter and the like 59 of Example 13 (FIG. 14). Thus, if the orientation in Example 13 (FIG. 14) is referred to as the long side of a vertical orientation, then that in Example 14 (FIGS. 15 and 16) is the short side of a horizontal orientation.

### Example 15

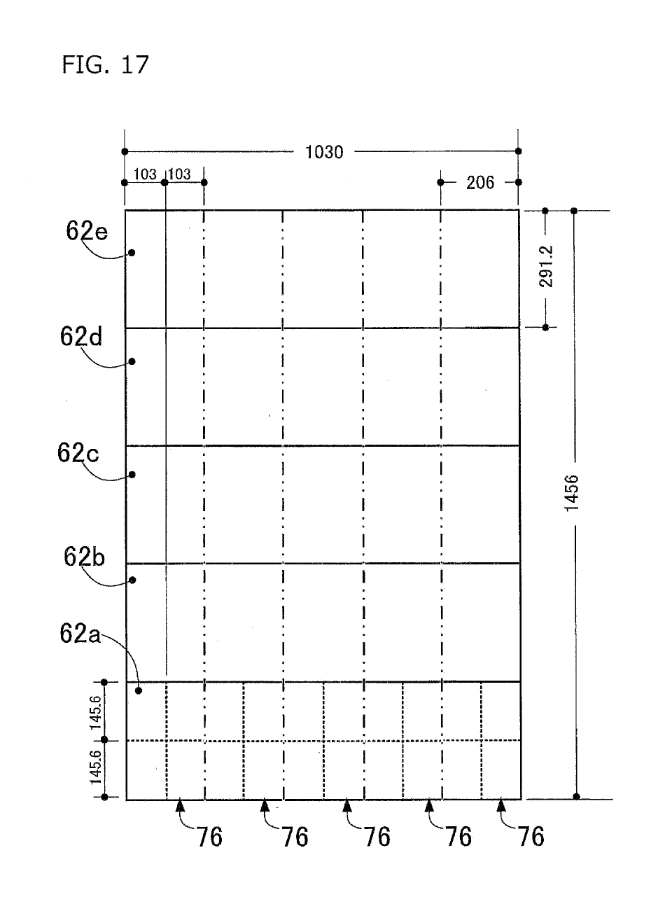

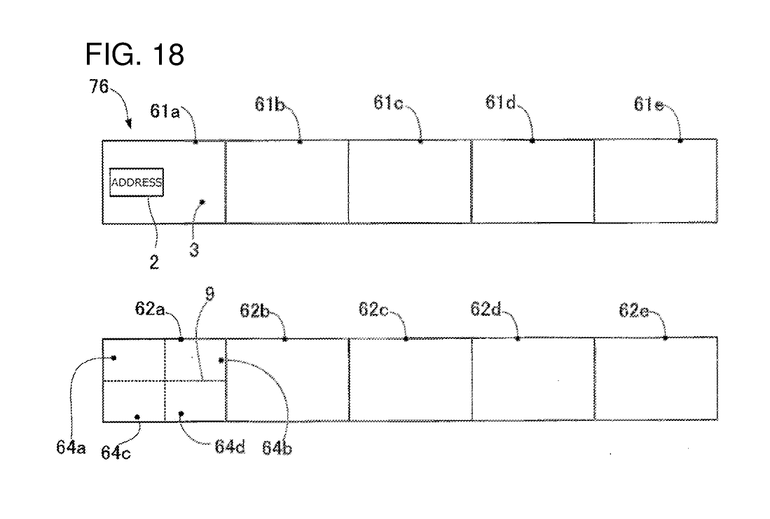

In Example 15 shown in FIGS. 17 and 18, a primary difference with the above-mentioned Example 14 is that Example 15 is a postal matter and the like 76 which differs from the postal matter and the like 75 of Example 14 in orientation of sections. In the postal matter and the like 76, a section for pre-addressed return mails and an address-described section 3, which is on the opposite side of the section for pre-addressed return mails, are provided on sections 62a and 61a which are provided on the side of the short side end. Therefore, after cutting out, a postal matter and the like having the form shown in FIG. 18 which the section for pre-addressed return mails and the address-described section 3 opposite side to the former are provided on the side of the short side end, may be obtained.

### Example 16

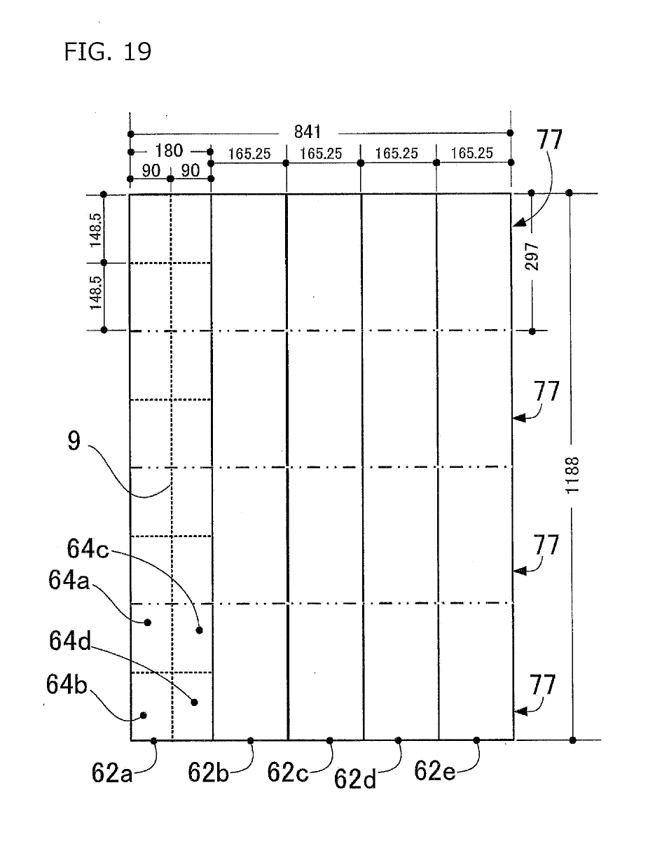

In Example 16 shown in FIG. 19, a primary difference with the above-mentioned Example 13 is that four postal matters and the like 77 are printed on a printing base paper which is AO size (the short side of 841 mm by the long side of 1188 mm), which a section for pre-addressed return mails and an address-described section 3 opposite side to the former are provided on sections 62a and 61a provided on the side of the long side end of the base paper.

In the postal matter and the like 77, the size of the section 62a for pre-addressed return mails and the address-described section 3 (the section 61a) opposite side to the former is referred to as the short side of 180 mm by the long side of 297 mm, each size of a first pre-addressed return mail 64a to a fourth pre-addressed return mail 64d is referred to as the short side of 90 mm by the long side of 148.5 mm (the range of unofficial postcard), and the size of other sections is referred to as the short side of 165.25 mm by the long side of 297 mm.

The width of the sections 62a and 61a only have to be that of which each size of the first pre-addressed return mail 64a to the fourth pre-addressed return mail 64d are within the range of unofficial postcard, and each size of sections 62b to 62e may be appropriately set.

Also, a section for pre-addressed return mails is referred to as the section 62a and the address-described section 3 opposite side to the section 62a is referred to as the section 61a in this example, but the location on which these sections are provided, may be appropriately set. The same can be applied to Examples 14 and 15.

### Example 17

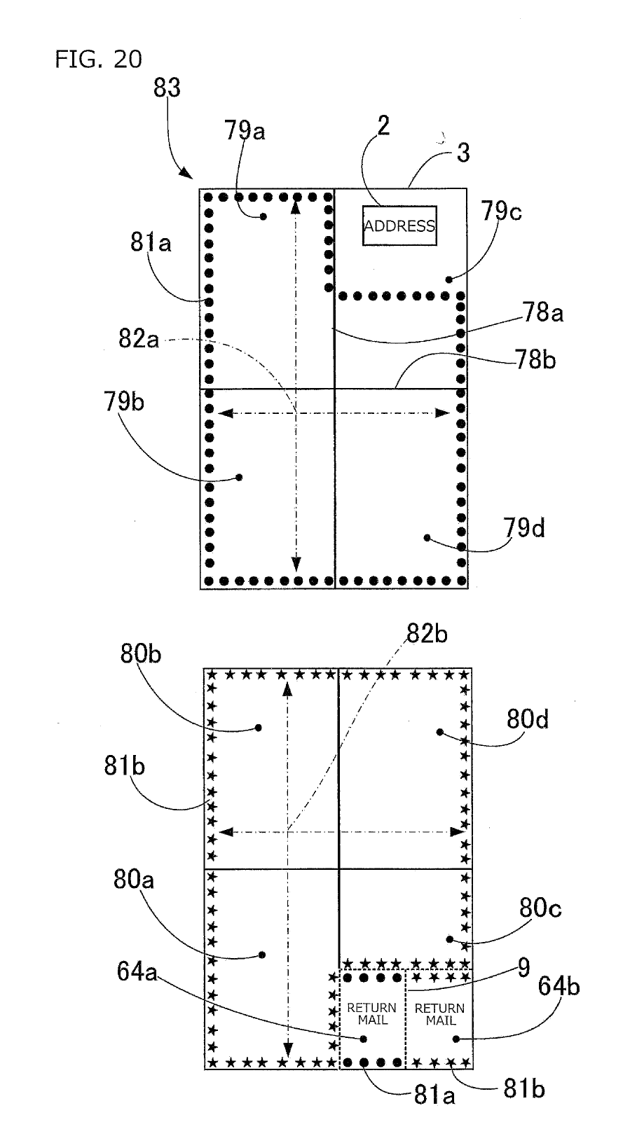

In EXAMPLE 17 of the present invention shown in FIG. 20, a postal matter and the like 83 is that:

wherein four sections 79a to 79d whose size is almost the same as A4 size, which is separated by a vertical folding line 78a and a horizontal folding line 78b, are formed on a A2 size sheet;

wherein four sections similarly formed on the back surface of the sheet, are referred to as sections 80a to 80d;

wherein the section 79c is referred to as an address-described section 3 and, in almost half of the opposite section 80c, a first pre-addressed return mail 64a and a second pre-addressed return mail 64b are described;

wherein a first identifying description 81a is described in the first pre-addressed return mail 64a, the sections 79a, 79b and 79d, and a part of the section 79c; and

wherein a second identifying description 81b is described in the second pre-addressed return mail 64b, the sections 80a, 80b and 80d, and a part of the section 80c.

The first identifying description 81a is described so as to surround the sections 79a, 79b and 79d, and a part of the section 79c to form a first advertising information-described portion 82a.

The second identifying description 81b is described so as to surround the sections 80a, 80b and 80d, and a part of the section 80c to form a second advertising information-described portion 82b.

A peel-openable adhesive is applied on an adhesion part, and the sheet is folded along the vertical folding line 78a and the horizontal folding line 78b, compression-bonded and adhered with the adhesion part to obtain the postal matter and the like 83 which four sheets having almost the same size as A4 size are folded and piled.

### Example 18

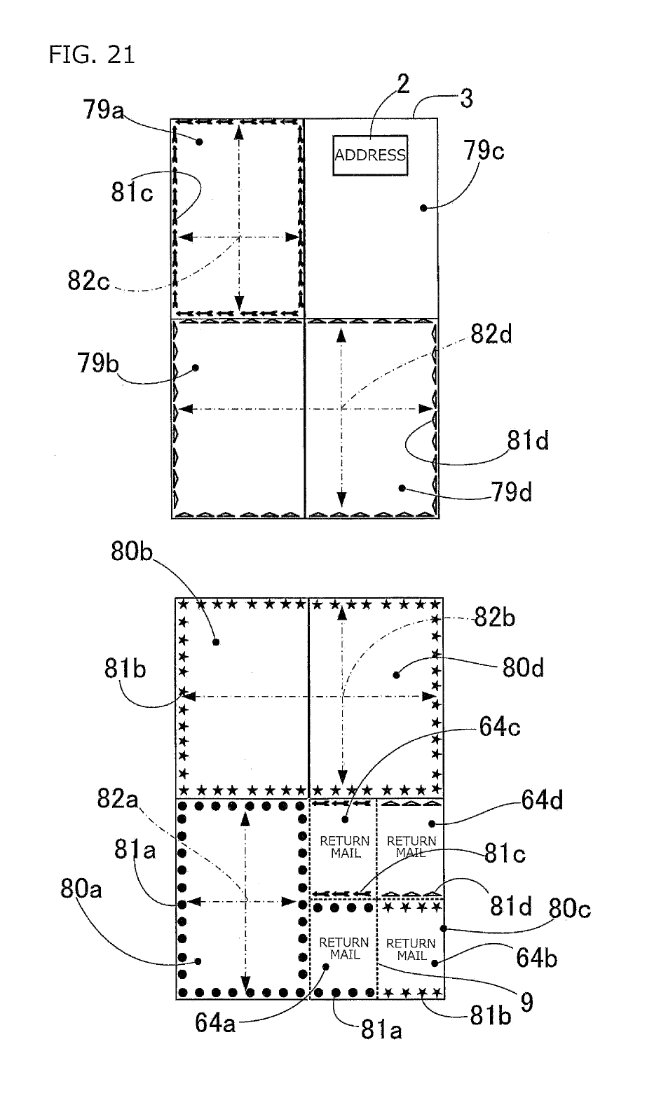

In Example 18 shown in FIG. 21, a primary difference with the above-mentioned Example 17 is that a postal matter and the like 85 is formed so as to have four pre-addressed return mails consisting of a first pre-addressed return mail 64a, a second pre-addressed return mail 64b, a third pre-addressed return mail 64c, and a fourth pre-addressed return mail 64d. These four pre-addressed return mails are provided on a section 80c, a third identifying description 81c is described in the third pre-addressed return mail 64c, a fourth identifying description 81d is described in the fourth pre-addressed return mail 64d. A section 79a is referred to as a third advertising information-described portion 82c, and the third identifying description 81c is described so as to surround the section 79a. Sections 79b and 79d are referred to as a fourth advertising information-described portion 82d, and the fourth identifying description 81d is described so as to surround the sections 79b and 79d. Sections 80b and 80d are referred to as a second advertising information-described portion 82b, and the second identifying description 81b is described so as to surround the sections 80b and 80d. A section 80a is referred to as a first advertising information-described portion 82a, and the first identifying description 81a is described so as to surround the section 80a.

### INDUSTRIAL APPLICABILITY

The present invention may be mainly applied to a business of agency sending a postal matter and the like.

### EXPLANATION OF LETTERS OR NUMERALS

S1: SHEET MEMBER
S2: SHEET MEMBER
S3: SHEET MEMBER
S4: SHEET MEMBER
1: POSTAL MATTER AND THE LIKE
2: POSTAL ADDRESS
3: ADDRESS-DESCRIBED SECTION
4: ADDRESSER-DESCRIBED PORTION
5: FIRST ADVERTISING INFORMATION-DESCRIBED PORTION
5a: FIRST ADVERTISING INFORMATION
6: SECOND ADVERTISING INFORMATION-DESCRIBED PORTION
6a: SECOND ADVERTISING INFORMATION
7: FIRST PRE-ADDRESSED RETURN MAIL
7a: FIRST RESPONSE PORTION
7b: FIRST PRE-ADDRESSED RETURN MAIL INFORMATION
7c: FIRST RETURN MAIL-IDENTIFYING PORTION
8: SECOND PRE-ADDRESSED RETURN MAIL
8a: SECOND RESPONSE PORTION
8b: SECOND PRE-ADDRESSED RETURN MAIL INFORMATION
8c: SECOND RETURN MAIL-IDENTIFYING PORTION
9: DOTTED LINE INSTRUCTED
11: INTRODUCTION-DESCRIBED PORTION
12a-12g: FOLDING LINE
13a-13h: FIRST SECTION-EIGHTH SECTION
14: POSTAL MATTER AND THE LIKE
15: IDENTIFYING DESCRIPTION
16: IDENTIFYING DESCRIPTION
18: OVERLAP WIDTH
19: DOTTED OPENING LINE
20: POSTAL MATTER AND THE LIKE
21a: IDENTIFYING DESCRIPTION
21b: IDENTIFYING DESCRIPTION
30: HORIZONTAL FOLDING LINE
31a, 31b, 31c: VERTICAL FOLDING LINE
33: FIRST ADVERTISING INFORMATION-DESCRIBED PORTION
33a: FIRST ADVERTISING INFORMATION
34: FIRST PRE-ADDRESSED RETURN MAIL
36: SECOND ADVERTISING INFORMATION-DESCRIBED PORTION
36a: SECOND ADVERTISING INFORMATION
37: SECOND PRE-ADDRESSED RETURN MAIL
38: POSTAL MATTER AND THE LIKE
39: THIRD ADVERTISING INFORMATION-DESCRIBED PORTION
39a: THIRD ADVERTISING INFORMATION
40: THIRD PRE-ADDRESSED RETURN MAIL
42: POSTAL MATTER AND THE LIKE
43: FIRST IDENTIFYING DESCRIPTION
44: SECOND IDENTIFYING DESCRIPTION
45: THIRD IDENTIFYING DESCRIPTION
47: INTRODUCTION SENTENCE
48: INTRODUCTION SENTENCE
50a, 50b, 50c: HORIZONTAL FOLDING LINE
51a: FIRST ADHEREND SURFACE
51b: SECOND ADHEREND SURFACE
56: POSTAL MATTER AND THE LIKE
59: POSTAL MATTER AND THE LIKE
60a: FIRST FOLDING LINE
60b: SECOND FOLDING LINE
60c: THIRD FOLDING LINE
60d: FOURTH FOLDING LINE
61a-61e: SECTION
62a-62e: SECTION
63: PRE-ADDRESSED RETURN MAIL-DESCRIBED SECTION
64a: FIRST PRE-ADDRESSED RETURN MAIL
64b: SECOND PRE-ADDRESSED RETURN MAIL
64c: THIRD PRE-ADDRESSED RETURN MAIL
64d: FOURTH PRE-ADDRESSED RETURN MAIL
65a: FIRST ADVERTISING INFORMATION
65b: SECOND ADVERTISING INFORMATION
65c: THIRD ADVERTISING INFORMATION
65d: FOURTH ADVERTISING INFORMATION
66a: FIRST ADVERTISING INFORMATION-DESCRIBED PORTION
66b: SECOND ADVERTISING INFORMATION-DESCRIBED PORTION
66c: THIRD ADVERTISING INFORMATION-DESCRIBED PORTION
66d: FOURTH ADVERTISING INFORMATION-DESCRIBED PORTION
67a: FIRST IDENTIFYING DESCRIPTION
67b: SECOND IDENTIFYING DESCRIPTION
67c: THIRD IDENTIFYING DESCRIPTION
67d: FOURTH IDENTIFYING DESCRIPTION
70: POSTAL MATTER AND THE LIKE
74: POSTAL MATTER AND THE LIKE
75: POSTAL MATTER AND THE LIKE
76: POSTAL MATTER AND THE LIKE
77: POSTAL MATTER AND THE LIKE
78a: VERTICAL FOLDING LINE
78b: HORIZONTAL FOLDING LINE
79a-79d: SECTION
80a-80d: SECTION
81a: FIRST IDENTIFYING DESCRIPTION
81b: SECOND IDENTIFYING DESCRIPTION
82a FIRST ADVERTISING INFORMATION-DESCRIBED PORTION
82b: SECOND ADVERTISING INFORMATION-DESCRIBED PORTION
83: POSTAL MATTER AND THE LIKE

1. A postal matter and the like comprising;
a sheet member being folded one or more times and adhered peel-openably, or being folded and adhered so as to enable to cut out an edge to open the folded sheet member;
wherein the sheet member has several sections defined by folding lines;
one of the sections or a part thereof is defined as an address-described section which a postal address of one of the targeted people is described; and,
the other remaining sections are allocated to a first advertising information-described portion to a nth advertising information-described portion on each of which a first advertising information to a nth advertising information are printed respectively relating to a first advertiser to a nth advertiser, and a first pre-addressed return mail to a nth pre-addressed return mail which is able to be separated for mailing to the first advertiser to the nth advertiser.

2. The postal matter and the like according to claim 1, wherein the sheet member has;
an identifying description which is printed on one or more sides selected from upper, lower, right and left sides of each printed advertising information to visually distinguish each of the advertising information easily; and
other identifying description which is the same or almost the same as the said identifying descriptions and which is printed in each pre-addressed return mail corresponding to each advertising information.

3. The postal matter and the like according to claim 1, wherein;
the first pre-addressed return mail to the nth pre-addressed return mail comprise the first pre-addressed return mail and the second pre-addressed return mail, the first pre-addressed return mail to the third pre-addressed return mail, or the first pre-addressed return mail to the fourth pre-addressed return mail; and
the first advertising information to the nth advertising information comprise the first advertising information and the second advertising information, the first advertising information to the third advertising information, or the first advertising information to the fourth advertising information.

4. The postal matter and the like according to claim 2, wherein;
the first pre-addressed return mail to the nth pre-addressed return mail comprise the first pre-addressed return mail and the second pre-addressed return mail, the first pre-addressed return mail to the third pre-addressed return mail, or the first pre-addressed return mail to the fourth pre-addressed return mail; and
the first advertising information to the nth advertising information comprise the first advertising information and the second advertising information, the first advertising information to the third advertising information, or the first advertising information to the fourth advertising information.

5. The postal matter and the like according to claim 1, wherein;
all of the pre-addressed return mails are printed in one of the sections defined as a pre-addressed return mail-described section; and
a back side of the pre-addressed return mail-described section is to be the said address-described section.

6. The postal matter and the like according to claim 2, wherein;
all of the pre-addressed return mails are printed in one of the sections defined as a pre-addressed return mail-described section; and
a back side of the pre-addressed return mail-described section is to be the said address-described section.

7. The postal matter and the like according to claim 3, wherein;
all of the pre-addressed return mails are printed in one of the sections defined as a pre-addressed return mail-described section; and
a back side of the pre-addressed return mail-described section is to be the said address-described section.

8. The postal matter and the like according to claim 4, wherein;
all of the pre-addressed return mails are printed in one of the sections defined as a pre-addressed return mail-described section; and
a back side of the pre-addressed return mail-described section is to be the said address-described section.

9. The postal matter and the like according to claim 1, wherein at least the first advertiser is a publicly-quoted company and advertisers other than the first advertiser are non publicly-quoted company selected from a stock unlisted company, an unlisted organization and a solo proprietor.

10. The postal matter and the like according to claim 2, wherein at least the first advertiser is a publicly-quoted company and advertisers other than the first advertiser are non publicly-quoted company selected from a stock unlisted company, an unlisted organization and a solo proprietor.

11. The postal matter and the like according to claim 3, wherein at least the first advertiser is a publicly-quoted company and advertisers other than the first advertiser are non publicly-quoted company selected from a stock unlisted company, an unlisted organization and a solo proprietor.

12. The postal matter and the like according to claim 4, wherein at least the first advertiser is a publicly-quoted company and advertisers other than the first advertiser are non publicly-quoted company selected from a stock unlisted company, an unlisted organization and a solo proprietor.

13. The postal matter and the like according to claim 5, wherein at least the first advertiser is a publicly-quoted company and advertisers other than the first advertiser are non publicly-quoted company selected from a stock unlisted company, an unlisted organization and a solo proprietor.

14. The postal matter and the like according to claim 6, wherein at least the first advertiser is a publicly-quoted company and advertisers other than the first advertiser are non publicly-quoted company selected from a stock unlisted company, an unlisted organization and a solo proprietor.

15. The postal matter and the like according to claim 7, wherein at least the first advertiser is a publicly-quoted company and advertisers other than the first advertiser are non publicly-quoted company selected from a stock unlisted company, an unlisted organization and a solo proprietor.

16. The postal matter and the like according to claim 8, wherein at least the first advertiser is a publicly-quoted company and advertisers other than the first advertiser are non publicly-quoted company selected from a stock unlisted company, an unlisted organization and a solo proprietor.
